(19) United States
(12) Patent Application Publication
(10) Pub. No.: US 2003/0177060 A1
(43) Pub. Date: Sep. 18, 2003

(54) System and method for return on investment

(76) Inventor: Theresa L. Seagraves, Parker, CO (US)

Correspondence Address: SHERIDAN ROSS PC, 1560 BROADWAY, SUITE 1200, DENVER, CO, 80202

(21) Appl. No.: 10/095,679

(22) Filed: Mar. 12, 2002

(51) Int. Cl. G06F 17/60

(52) U.S. Cl. 705/11

(57) ABSTRACT

A system and method for return on investment are provided for determining the value of a performance enhancing program utilizing iterate data collection which better measures objectives achieved by participants in the program, measured in the form of a return on the investment. The investment can be defined by the costs and benefits associated with undertaking the program and conducting a study which measures the value of the program. The system and method are incorporated with a data progressing system which allows transfer and manipulation of the large amount of data, and also enables the method to be achieved even though participants may be geographically dispersed. A number of reports and visual data may be created by the data processing system which helps participants and their managers to visualize the impact of the program on their organization.

### FIELD OF THE INVENTION

This invention relates to methods and systems for determining the value of performance management programs such as training, and more particularly, to a method and system for determining the value of the performance management programs utilizing iterative data collection which better measures objectives achieved by participants in the programs in the form of a return on the investment, the investment being the cost and benefits associated with undertaking the training and conducting a return on investment study.

### BACKGROUND OF THE INVENTION

Performance management programs are important for not only maintaining performance of an organization, but also for enhancing the performance of the organization and ensuring its long term livelihood. Although the intent of these programs is to provide certain benefits for the organization, there are always costs associated with undertaking training. For example, employee training takes employees away from their normal duties which means that the employees are not achieving their normal tasks for the organization. Additionally, training has other costs to include maintaining a training staff, training facilities, and all of the materials and other resources which are used to maintain a training department within an organization.

In recent years, there have been studies made in attempts to determine the value of performance management programs for an organization. Many of these studies have focused upon the change of state or status in an organization in terms of how an organization improves after undergoing a program. In these studies, comparisons are made between the performance of a particular individual or group of individuals before and after training. The goal in all of these studies was to determine the degree to which the training was responsible for changes in the performance of the organization. These are traditional studies; however, oftentimes the actual costs for conducting the program are not incorporated within an analysis of how an organization changes or improves due to the training. Training can be considered a cost to the organization in terms of the resources required to conduct the training.

Other recent studies have made attempts to define the value of training based upon training being an investment, and the return which an organization realizes by participating in the training. The return on investment process was developed by Dr. Jack J. Phillips, the author of the book entitled “Return on Investment in Training and Development Programs”. An updated version of Dr. Philip's process is also published in a book entitled “In Action: Measuring Return on Investment”, Vol. 3. In the return on investment (ROI) process described in these publications, the process in determining the value of the training to the organization is set forth in a process which includes evaluation planning, data collection, data analysis, and reporting. As discussed below, the ROI process as developed by Dr. Jack Phillips has become a well known industry standard in determining return on investment for training.

While Dr. Phillips' process has been able to provide a method which quantifies the value of training or other management programs for an organization, the invention disclosed herein has certain additional benefits and advantages in further providing the ability to provide an organization a measure of the value of programs undertaken. Because of the amount of information which may be used to gather data on a particular organization, the invention herein is best suited for implementation within an automated data processing system wherein data can be input and manipulated within a computer, and desired outputs may then be generated by the system. Automation in terms of handling the data within the ROI process disclosed herein further enhances the ability to provide an organization a timely, complete, and detailed analysis as to the value of the program.

Among other advantages mentioned below, the current invention provides for iterative data gathering steps throughout the ROI process which better validates the calculated return on the investment, as well as measuring other aspects of the organization's performance before and after the program event. Another aspect of the invention which helps to create more reliable reporting in terms of the value of the program is the ability of the program participants to also update their impressions of the program as a function of how much of the organization's improved performance is due to the program event.

Because there is iterative or repeated data gathering and evaluation steps, this also provides program participants and their managers with better information as to how their performance has changed since the program, which can subsequently result in even better performance for the organization because updated reporting on performance should result in increased incentive to achieve or obtain originally stated goals.

### SUMMARY OF THE INVENTION

In accordance with the invention, a method and system for a return on investment process is provided. In its simplest form, the method can be conceptualized as a set of steps which are used in gathering information about an organization prior to a performance management event such as training, determining the costs of the training, targeting a desired return on investment for the training, conducting the training, and then utilizing an iterative series of additional data gathering steps to determine how the organization has changed after the training, the measure of improved or decreased performance being stated in terms of a return on investment which measures therefore the value of the training.

Although the method and system described herein refers specifically to a training program for an organization, it shall be understood that the method and system of this invention can be utilized within any type of performance management program wherein an organization undertakes some type of program in an attempt to improve their performance, to restructure their organization, to effect some change in the organization, or otherwise alter a general state into a desired state. Organizational training is therefore but one example in which the method and system of this invention can be utilized.

The method is best incorporated within an automated data processing system which can include one or more computers for data gathering, data manipulation, and generation of output in the form of reports which provide an analysis of the organizations performance before and after training and the return on investment. In its simplest form, the data processing system incorporated within the method of the invention could include one or more computers which allow participants in the training to input information regarding the status of their organization, their goals and objectives in the training, the degree to which they believe the training will be attributed to the improved performance, among many other types of information. One particularly advantageous arrangement could include the use of one or more sets of computers allowing data input for the participants in the form of survey participant computers, and their gathered data being transferred to a survey server or computer which receives the data from the students and organizes the data for ultimate incorporation within a desired reporting format. Data transfer in the data processing system can be addressed by any number of well known means to include the World Wide Web, local area networks, and others. This survey server allows many participants to input answers to survey questions simultaneously and from any location in the world. The survey server can also provide an additional security level representing confidentiality to the participants completing the survey and provide a security firewall arrangement separating a potentially large number of participants from sensitive organization data stored on another computer.

Another set of computers can be provided for data input by managers and training personnel who are also involved in the training event. Examples of this type of data could include sales quota levels, quality defect percentages, salary rates or other current performance information that the training is designed to affect or which is needed for cost measurement during the return on investment study. These computers could also allow the managers and training personnel to input and manipulate their choices for their return on investment goals. Each of these sets of computers could then communicate with another server, such as an organizational level server, which would receive the data input from the line manager/training personnel computers and from the survey participant computers. This additional server could also manipulate and organize the data for ultimate use within a particular type of reporting format more tailored to the line managers or the training personnel.

Optionally, yet another computer could be used in the form of an analysis server which could be tasked with conducting most of the data manipulation in terms of producing desired outputs such as graphs or other visual data showing numerical relationships between data points.

### BRIEF DESCRIPTION OF THE DRAWINGS

FIG. 1 is a simplified flow diagram showing the prior art return on investment process of Dr. Phillips;

FIGS. 2A and 2B are flow diagrams showing the return on investment process of the current invention;

FIG. 3 is a schematic diagram illustrating how the method of the invention can be incorporated within a data processing system;

FIGS. 4 and 5 are graphical diagrams illustrating how the method of the invention can generate organizational performance and activity information;

FIG. 6 is a graphical diagram illustrating how the method of the invention can generate organizational monetary benefit information;

FIG. 7 is a diagram illustrating a user interface screen which allows input of return on investment variables;

FIG. 8 is a graphical diagram illustrating how the method of invention can generate breakeven point and goal trend analysis; and

FIG. 9 is a user interface screen illustrating how the method of the invention can display projected and actual return on investment values.

### DETAILED DESCRIPTION

One convenient way in which to further describe the method and system of this invention is to begin first with a brief description of the ROI process as developed by Dr. Jack Phillips. Both publications mentioned above, namely the book entitled “Return on Investment in Training and Performance Improvement Programs”, copyright 1997 by Gulf Publishing Company, and the book entitled “In Action: Measuring Return on Investment”, Vol. 3, copyright 2001 by The American Society for Training and Development, are hereby incorporated by reference in their entirety.

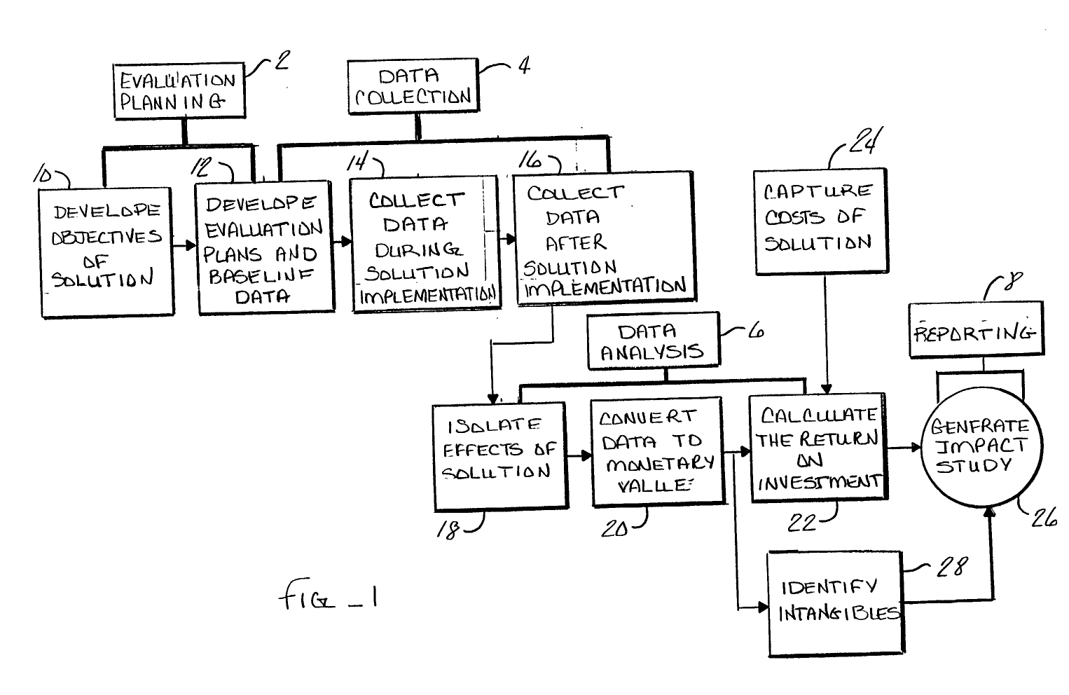

FIG. 1 illustrates the prior art method which is disclosed in the publications of Dr. Phillips. FIG. 1 represents only a brief summary or overview of the steps involved in the ROI process. One conceptual way in which to view his process is within four basic phases, namely, evaluation planning 2, data collection 4, data analysis 6, and reporting 8.

Within the evaluation planning phase or stage 2, some of the primary tasks include developing objectives for the solution (the solution being the goals to be achieved) and developing evaluation plans and baseline data. In the data collection phase 4, the primary steps or tasks include an overlap of evaluation planning and data gathering, collecting data during solution implementation, and collecting data after solution implementation. The training event occurs prior to collecting data during solution implementation. During the data analysis phase 6, the primary tasks or steps include isolating the effects of the solution, converting the data gathered to monetary value, and calculating the return on the investments. Isolating the effects of the solution involves analyzing to what degree the training is responsible for the solution obtained. Calculating the return on the investment requires that one must capture the cost of the solution. Finally in the reporting phase 8, an impact study is created which provides a full analysis of the impact on the organization due to the training and the solution obtained. Also important in generating the impact study is an identification of intangibles which may not be directly calculated within the return on the investment, but are nonetheless important in generating a final report.

From the foregoing brief overview of Dr. Philip's process, it can be seen that the ROI process of Dr. Phillips is a fairly linear progression of steps wherein calculation of the return on investment leads directly to a final impact study. While Dr. Philip's process is understood in the art as being a breakthrough process in helping organizations define the value of their training and performance programs, the invention disclosed herein has a number of modifications and changes which result in a distinct ROI process.

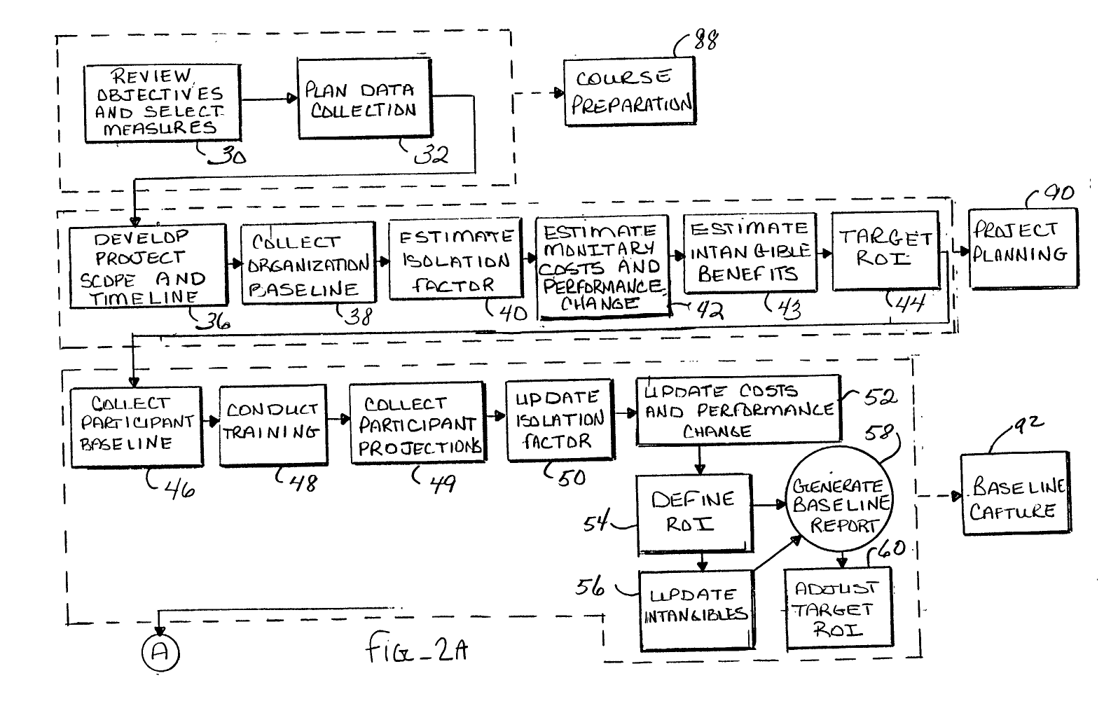

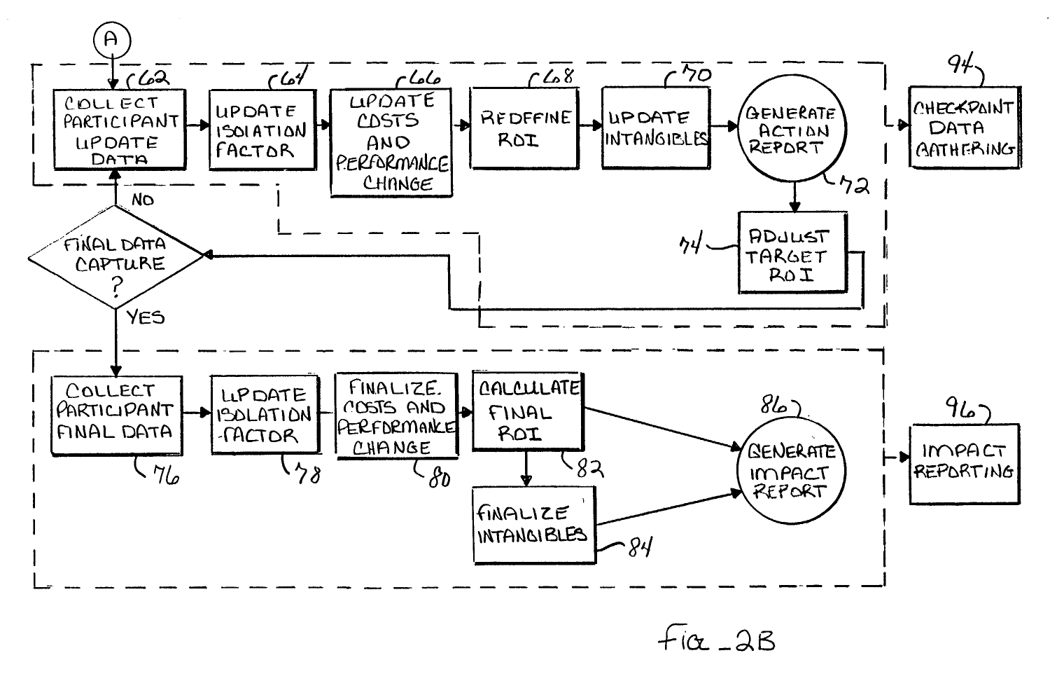

FIGS. 2A and 2B are flow diagrams which provide a basic framework for understanding the method of the current invention. This particular flow diagram is provided for an overview or summary of the process, and the specific steps disclosed in the figures should not be interpreted as each being critical to the method of the invention. It should also be understood that numerous additional steps within the method can be incorporated, as further discussed below.

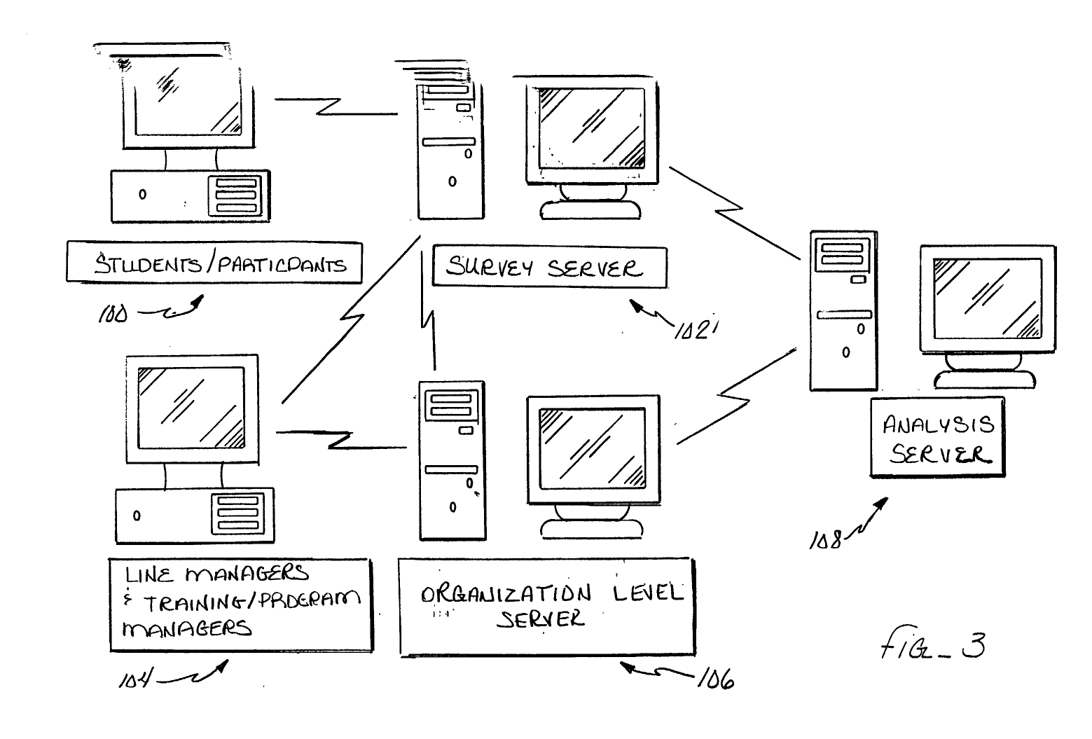

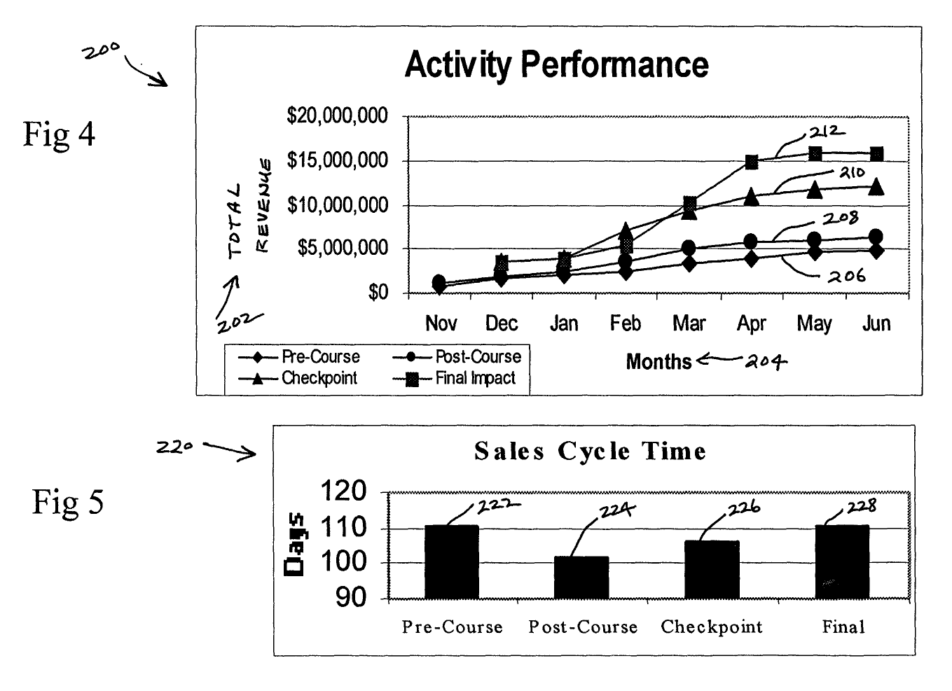

Beginning now with a description of FIG. 2A, an initial step in the process is for reviewing objectives and selecting measurements which can measure on the job performance, shown in step 30. Therefore, the performance objectives chosen should be objectives which can be illustrated in the form of a graph or other visual indicator which is able to actually measure a change in the performance before and after the training. For example, in a sales training course, one of the objectives might be to raise the level of the amount of sales for a given period of time. Therefore, the performance objective would be to raise the amount of sales, which can easily be shown in the form of a graph which illustrates the amount of sales over a given time period prior to and after the training course. Preferably, the graphs or visual indications of the performance objectives should be kept simple and easily understood. Examples of possible graphs can be seen in FIGS. 4 and 5, as further discussed below.

A next principle step in the method is planning data collection, shown as step 32. In this step, consideration is given as to the type of data which will be used to support measurement of the performance objectives, and calculating the ROI. Two common data collection solutions are to collect data from participants in the training, and the supervisors or managers who may not necessarily attend the training, but can provide data regarding the participants and their organization. The actual methods by which data can be collected include, but are not limited to, observation, estimation, surveys, or personal interviews with individuals. For any of these methods, there must be a consistent set of questions and data collected. Also in this planning of data collection, a set of questions should be developed as to determining the organizational baseline, i.e., the current state of the organization prior to training supported by data regarding a level of performance of the organization. For example, for a sales department, organizational baseline questions might include determination of the average sale or deal size, how much average discount is given on the deals, current sales growth rate, industry average growth rate, and required quotas per sales person. As discussed further below, this organizational baseline data is used to support cost estimates and other reporting information.

The next step illustrated is step 36 which includes developing a project scope and time line. In this activity, it is necessary to determine two key questions, namely, (1) when should the ROI study or analysis be complete and (2) after the training is conducted, how many times is it recommended to follow up with the students and the organization to determine how they are implementing their action plans. As for the first question, the time necessary to complete the ROI study is a function of how long will it take to capture a time period in which performance can be accurately measured based upon the performance objectives set out in the beginning of the process. For example, in the sales related environment, the ROI study would at least include a period of time in which a desired number of sales cycles were covered. If the ROI analysis was completed prior to an average sales cycle, it would be difficult, if not impossible to determine a change in performance of the organization if sales cycles were obvious time periods in which to analyze performance. As for the second question, the number of required follow ups is a function of the type of tasks which are being measured, as well as the type of organization studied. For some organizations, it may be necessary to conduct numerous follow-ups in terms of updating cost estimates, as well as performance objectives being realized on the job. For other organizations, fewer follow-ups may be necessary to confirm and validate earlier estimates made.

The next step shown in the method is step 38, collecting the organization baseline. As discussed above with regard to planning data collection, obtaining information about the organization's current status is an important set of data to be obtained. Thus in this particular step, the actual data is collected for determining the organization's baseline or current status, and then this information can be used for later estimate of costs, as well as showing a change in the organizations baseline based upon performance after completion of the training.

Step 40 requires an estimate of the isolation. The term “isolation” refers to a measure of how much of the success of the organization in achieving their performance objectives can be attributed to the training. Typically, the isolation estimate is provided in terms of a percentage for example, participants in the training may make an initial estimate that the training will be responsible for 25% of the improved performance. A specific example for determining isolation can be given again for a sales environment wherein an isolation questions would be how much of the future sales dollars do the participants believe should be credited to the training.

The next major step in the process is to estimate the costs which are incurred by participating in the training event, and the value of the changed performance activities that the training is designed to impact shown as step 42. These training costs and the value provided in terms of changed performance are assigned monetary values, thus providing a tangible measurement as to what has to be given up in order to conduct the training and what may be gained by conducting the training. The value of the changed performance can also be thought in terms of required revenue to be generated by the organization in order to cover the costs of the training event. Thus, the performance activities of the organization can be broken down into revenue producing activities (such as sales revenues) and then determining what the organization normally would produce during the time period of the ROI study, and contrast that with the actual revenue generated during the period of the ROI study.

The cost of the training also includes the cost involved in conducting the ROI study which measures the effectiveness of the training. By determining costs, one then can estimate the required revenue to cover the costs. This first analysis of costs provides an opportunity to determine whether even to consider the training and the ROI study. If the costs are too high, it may be infeasible to conduct the training.

One convenient way in which to capture costs is to provide cost data in the form of tables which list each of the costs by category, and then the various costs to determine a total cost. In determining costs, some of the categories of the costs may include training department overhead, meals, travel and incidental expenses for the participants of the training, and long distance telephone charges associated with conducting the training and the ROI study. It is also important to calculate the number of manpower hours lost by conducting the training which is a function of the number of participants, and the number of hours the participants spend in the training and participating in the ROI study. These hours can then be converted to dollar figures corresponding to what each participant normally produces for the organization in terms of revenue, or the revenue opportunities which are lost by attending the course over a certain period of time. For example, in the sales area, one could calculate a sales opportunity costs expense which would be a function of the amount of sales expected to be produced within an average time period, and then determining the number of potential lost sales by participants attending the training and participating in the ROI study. Yet other costs which may be applicable would include the cost for training department staff to conduct training (personnel costs), materials and supplies used to support the training, and facilities costs. Depending upon the type of organization and the type of training to be conducted, an in-depth analysis can be made as to each of the costs associated with conducting the training. Once the training is completed, there are additional costs in attending to the ROI study. For example, there are also costs associated with gathering data after the training is completed, which can be defined as checkpoint data gathering costs. Examples of these type of costs would include the training department staff employee costs involved with gathering the additional data, and the costs for the training participants who must take time from their job to provide additional information on their activities in the workplace after training. Finally, there are also impact reporting costs which are those costs incurred by administering an impact survey, analyzing the results, and preparing reports and presentations for the impact survey. Just as with the checkpoint data gathering costs, the impact reporting costs may include training department costs, participant costs, and others. Once each of the costs has been identified and monetary values assigned to the costs, the costs are added together to form total initial estimated costs.

The changed performance activities also need to be converted into monetary units. In a sales example, the same calculation for hourly value of sales lost due to conducting the training may also be used to show the potential monetary gain from conducting the training. In other examples, the value of reduced accident rates, decreases in late loan payments, increases in attendance or discrete actions can be assigned a monetary value to be used later in calculating the return of the training investment.

An additional step shown in FIG. 2A is estimating intangible benefits, as shown in block 43. For intangible benefits, these include the benefits that the participants expect the training program to create, and which cannot necessarily be assigned a monetary value. For example, there may not be data available which can measure certain benefits, or if there is data available, it is too difficult, costly, or unreliable for collection. Alternatively, the intangible benefits could represent a general attitude of feeling that is important to the organization but which cannot be converted into a monetary value. Examples of intangible benefits could include increased confidence to perform a particular job, higher trust in the organization, etc.

The next step shown in FIG. 2A is step 44, target the return on investment. In this step, the participants or the managers responsible for the participants determine what is their minimum acceptable return on the investment for the time period of the study. This target ROI goal is an initial estimate, and is updated as further discussed below. FIG. 10 shows a potential user input screen which allows this value to be input and manipulated by participants, managers or training personnel. FIG. 10 is also discussed further below.

In order to achieve the ROI goal, the revenue during the study period must exceed the costs associated with the training. In a standard cost benefit analysis, the rate of return would simply be calculated by benefits minus costs divided by costs. In the ROI process of this invention, as well as the process described in Dr. Philip's publications, reaching the target ROI goal requires not only an increase in revenue to cover costs and to cover the expected return, but also, the isolation estimate is taken into account in order to validate the perceived value of the training.

The required revenue during the study period can be calculated per participant of the training, and then the total of the participant's required revenue is then added to the normally expected revenue for the organization during the time period of the study. In other words, the organization's normally expected revenue constitutes one component of the required revenue, and the participants expected revenue (which factors in the isolation estimate and the ROI) is taken into consideration as another component of the required revenue. For example, the required revenue per person is that revenue which is required to cover the estimated cost per participant and this figure then is multiplied by the minimum acceptable ROI (a percentage greater than one, for example, an ROI of 25% would result in multiplying by 1.25).

The isolation credit or estimate is then used as a multiplier. Therefore, the product of the revenue to cover costs and the ROI is then multiplied by the inverse of the isolation estimate. For example, if the isolation estimate was 25%, the multiplier would be a factor of four (1÷0.25). Incorporating this multiplier provides the minimum required gross revenue per participant. Thus, the overall performance of the organization for the period of the study is also taken into consideration in addition to the revenue expected by the actual participants in the training.

Thus, an initial targeted ROI is determined prior to actual conducting of the training. Providing this target ROI early on allows all involved in the training to understand what type of performance is expected back on the job after training, and serves as an early goal for each of the participants and the organization to strive for.

Still prior to actually conducting the training course, the initial organizational baseline estimates established in step 38 are now further refined by collecting participant baseline data in step 46. This baseline data can be obtained in the form of a survey sent to each of the participants, and can also be sent to the participants supervisors to confirm the accuracy of the baseline data which is provided by the participants. As an example, in a sales type training course for a business, some of the baseline questions could include estimated deal size, estimated sales cycles, estimated discount percentages in the sales, among other information. The baseline data can also include a number of other more subjective type questions such as questions regarding the benefits that the participants believe that they may obtain by participating in the training and also participating in the ROI study. The next step in the process is the actual conducting of the training, shown as step 48. After training is completed, in order to help focus the participants on improving their performance, action plans can be generated which are simply a schedule of tasks which they should attempt to achieve in order to put into place the teachings of the training.

The next step shown is step 49. Immediately after training is completed, a second set of data is collected which reflects changes in the participants's estimates of their baseline data, collected in step 46. These changes in step 49 enable the first projections of potential performance to objectives, benefits to the organization and trend line projection of the breakeven point and time to reach the ROI goal. Also, in order to help focus the participants on improving their performance, action plans can be generated which are simply a schedule of tasks which they should attempt to achieve in order to put into place the teachings of the training.

The next step shown is updating the isolation at step 50. Now that the participants have concluded the training, it is important again to ask the participants how much credit they believe should be given to the course in terms of enhanced performance back on the job. This updated isolation may be a percentage higher or lower than initially estimated.

The next step shown is updating the initially estimated costs and projections in organizational performance changes, which inherently alter costs, in step 52. Now that the training has been completed, it is now easier to confirm some of the costs and projections of how the organization will perform (i.e., revenue producing activities performed by participants and the overall organization). Therefore, the extensive listing of costs tables can be updated as necessary to capture any additional costs which have been incurred, or costs which were never realized during the training. Updating these costs and projected performance changes would again involve participation of the training personnel, participants, and managers of the organization to update the estimated costs and projections.

Once the costs have been updated, the next step shown is step 54 which is to refine the initially targeted ROI. By knowing the updated costs as well as the updated isolation factor, the required revenue to cover costs and meet the ROI goal can also be analyzed again. If costs are too high or are unexpectedly low, the ROI can be adjusted at step 54.

The next step shown is updating the initially estimated intangible benefits at step 56. Again since the training has been conducted, the participants will have a better feel for defining the intangible benefits which they expect the training to provide.

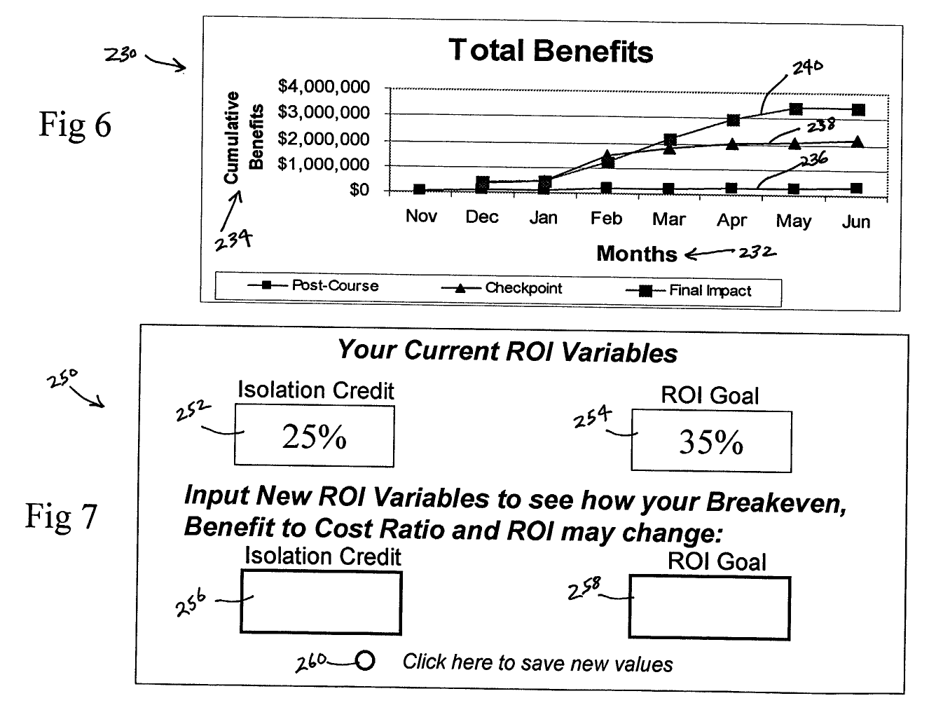

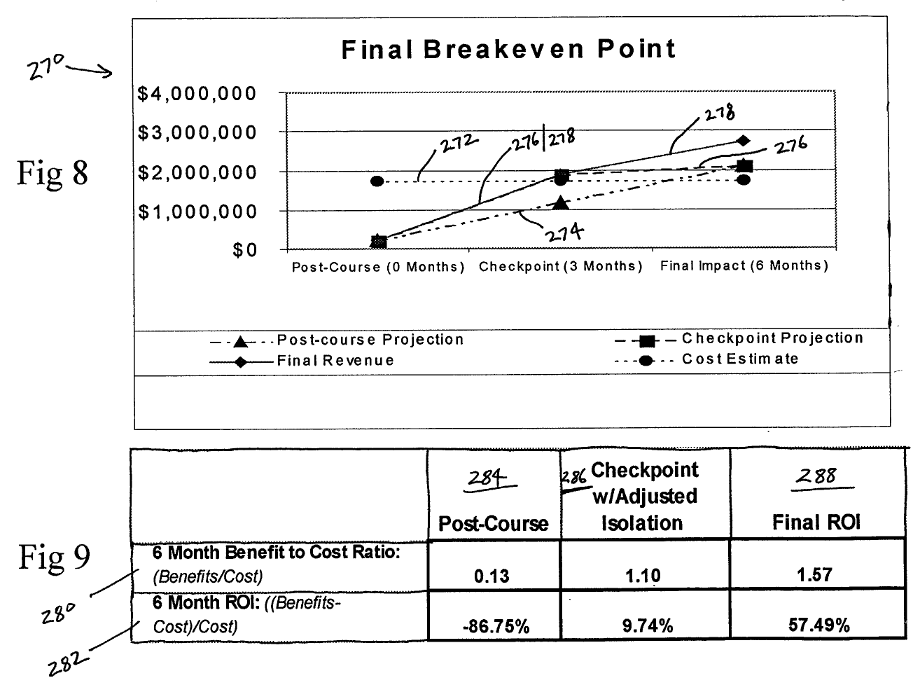

The next step shown is generating a baseline report at step 58. The primary purpose of the baseline report is to set forth what is expected from the participants now that the training has been completed. These expectations are found in the form of the targeted return on investment, as well as addressing the estimated intangible benefits. A typical format for the baseline report could include an executive summary which sets forth the project objective, i.e., measuring the return on the investment, along with any other objectives which have been set forth for the training. The report could also include the scope of the ROI study, and baseline projections which would include not only the required additional revenue to meet the ROI goal and cover costs, but also an estimated break even point which estimates when the organization will cover costs and meet its ROI goal, but not necessarily exceed its ROI goal. The baseline report could also include various recommendations as to how the participants can maximize the effectiveness of the training that they have received. The baseline report may contain generated graphs similar to the performance graphs shown in FIGS. 4 and 5, the benefits graph shown in FIG. 6, to the breakeven trend projection shown in FIG. 8 and to the projected return on investment shown in FIG. 9. One difference in the graphs and figures included in a baseline report is that only the available information at this step can be displayed, therefore only pre-training, post-training and cost estimate lines or data would be depicted. Alternatively, these graphs or data could be viewed online instead of in a printed form.

A number of graphs or other visual aids can be provided in the baseline report which indicate how the participants believed their performance would be before the class began and compared with how they believe their performance would be after the class was over. These comparisons of what participants believe they can perform can also placed in terms of the ROI goal and the amount of revenue which must be generated until the end of the study period. Thus, projected performance by the participants is provided in a format so they may also see how their projected performance meets with their ROI goal. It is also important in the baseline report to again review cost calculations. These cost calculations can be summarized from the various cost tables to provide an understandable analysis of how costs were captured. Also, it is important to review the required revenue which must be obtained in order to cover costs and obtain the ROI goal. Additionally, a discussion of the estimated isolation is also important in the baseline report to provide confirmation as to how participants perceive the importance of the training which they have just completed, and how that training will be attributed to future improvement of the organization.

After the baseline report has been generated, the participants, training personnel or managers in the organization are approached again to determine whether there is a need to adjust the target ROI at step 60. After generation of the refined ROI in step 54, and after submitting the baseline report to the participants and the organization for review in step 58, it may become necessary again to adjust the targeted ROI because the participants, training personnel or managers now have a much clearer view on how the training will be implemented in the work place. Thus, they have a much better idea on how their performance can be used to meet the ROI goal.

Steps 62-74 illustrate another iteration of steps which correspond closely to steps 46-58. More specifically, steps 62-74 represent another iteration or refinement in the process which ultimately allows one to yet further adjust the targeted ROI. These steps also take place during a selected period of time when participants are back on the job and are implementing the training they have participated in.

Steps 62 is shown as collecting participant update data. This step is conducted at some selected time after the training when students are actually putting to use the training they have received, and there is now tangible data available in terms of their performance on the job. Thus, the participants baseline data and projected performance data is now updated with actual data which supports their performance on the job. Collecting the participant update data in this step can again be done in the form of a survey which is provided to the participants, their managers, and others.

Step 64 is shown as again updating the isolation factor. Because participants are now back on the job, they may be able to better realize the value of the training, and how they can assign a percentage of their success on the job to the training they have received.

Step 66 shows a further update of the costs and values to the organization. Again since the training has been completed, better data may be available for updating the actual cost and value of the training. Step 68 is shown as another refinement in the ROI. Since costs and an updated isolation factor are available, the required revenue to meet the ROI goal can be calculated again. Step 70 shows yet another iteration in updating the estimated intangible benefits which at this point in time in the study, are now intangible benefits that can be seen by on the job performance.

Step 72 is shown as generation of an action report. This action report 72 can include information back to the participants and their managers regarding the progress of the participants in obtaining the ROI goal. It can also set forth trends through graphical analysis as to how performance is being achieved in terms of the targeted ROI for the project duration.

Step 74 indicates that again the targeted ROI may be adjusted based upon progress or lack of progress which has occurred after training.

Steps 62-74 may be repeated as necessary to obtain continual updated data and to both confirm and verify each of the elements which make up the ROI study. For short duration projects, it may be only necessary to conduct steps 62-74 once. In long term studies, it may be necessary to conduct steps 62-74 a number of times.

The final steps in the ROI process are illustrated as steps 76-86. These steps constitute the final data gathering in the process which leads to the ultimate reporting of the progress of the participants and the organization and whether the participants and the organization met their ROI goal. As shown in step 76, there is a final collection of the participants data. As set forth above in step 62, this data gathering step can also be in the form of a survey presented to the participants and their managers.

Step 78 indicates a final update of the isolation factor. Now that the period of the study has ended, the participants should be able to now place a final value on the value of the training. Step 80 indicates finalizing costs and values which again allows required revenue or cost savings to be calculated, which in turn allows one to calculate the final ROI in step 82. Step 84 indicates also finalizing the intangible benefits of the training. Final step 86 indicates the generation of an impact report. The impact report can be very similar in format as the baseline report in which not only is the final ROI calculated along with the listing of the intangible benefits, but also numerous graphical representations can be provided as to progress of the participants and the organization over the period of the project.

There can be a large amount of data which is gathered in the ROI process. Examples of the types of data which can be gathered in the process, along with the various graphs and other representations of performance objectives, and other measures of the process can be found in applicant's publication entitled “The Bottom Line ROI” and filed as a U.S. Copyright Application on Mar. 12, 2002. This publication is hereby incorporated by reference in its entirety for purposes of illustrating the various tables, graphs, and other outputs and measurements which are used to support recordation of the process. Also, applicant's publication includes sample cost tables which help to discretely identify all the costs associated with conducting the training and the ROI study.

In order to summarize the above process, it may also be convenient to break the process down into five major phases. These phases are shown as the dotted lines encircling the various portions of the process. More specifically, also illustrated in FIG. 2 is the course preparation phase 88, the project planning phase 90, the baseline capture phase 92, the check point data gathering phase 94, and the impact reporting phase 96.

Although FIGS. 2A and 2B illustrate a specific sequence of steps, it shall be understood that the system and method of this invention shall not be limited to the specific sequence shown, as many steps can be completed concurrently with other steps. The primary sequence of the system and method is embodied in the five phases discussed above. Thus, the particular order of steps within any phase can be modified and still adhere to the principles of the invention described herein.

Because of the amount of data involved with conducting the ROI study, it is advantageous to incorporate the ROI study into a data management system which is preferably in the form of various interlinked computer systems in which data can be exchanged, manipulated, and allows generation of various reports. The interlinked computer systems may utilize the World Wide Web, local area networks, or any number of other well known networks which allow data transfer. FIG. 3 is one example of how the method of this invention may be incorporated within a data processing system. The students or participants may utilize one or more computers 100 for responding to the various surveys and other questions which are asked of the participants prior, during, and after the training event. This is illustrated in FIG. 3 as the student/participants computer systems 100. As well understood by those skilled in the art, the surveys or other questionnaires may be transmitted electronically to a survey server 102 which is a computer system for accepting the student data, organizing the student data, and providing the various measures of their performance objectives in the form of graphs or tables.

FIG. 3 also shows a computer system 104 available for various managers of the participants and training/program managers. This computer system may include one or more individual computers which are used by the managers for data input into the survey server 102, and to facilitate communications with training personnel or the participants themselves. Like the survey server 102, the organizational level server 106 also may accept data transmitted to it from the computer system 104, and may manipulate the data in order to provide desired output such as graphs or other representations as to how the ROI study is progressing. Particularly for large ROI studies that have a great number of participants, it may be convenient to dedicate the survey server 102 for accepting and organizing data from both the participants and the managers, while the server 106 can be dedicated for communicating with the survey server to take the data in the survey server 102 to produce the various graphical outputs for other data analysis that are found in the various reporting formats of the ROI study. Optionally, yet another server may be provided, shown as analysis server 108. In the event of a particularly large and complex ROI study, it may also be convenient to have a dedicated server whose sole function is to analyze the data gathered by the survey server, and then forward the analyzed data to the server 106 whose function would be to create the various reports and the graphical data to support the report formats.

FIG. 4 is a graph which may be produced from the method and system of this invention. Specifically, FIG. 4 is a graphical diagram illustrating activity performance information in the form of a graph 200 showing how an organization has performed over a study. In this example, the total revenue 202 generated by an organization is plotted against the time period of the ROI study, which is shown as running from the month of November through June. These months 204 simply represent one possible time frame in which an organization's performance may be evaluated in the ROI study. Within the graph, various lines are provided which represent the predictions or projections of the performance, as well as the actual performance. As shown, line 206 represents what the participant's believed the total revenue would be during the period of the study, this data being gathered prior to the course/training event. Line 208 represents the projection of the performance of the organization after the participant's have undertaken the course/training. Line 210 represents the performance of the organization as measured at some time after the course/training event, the data being gathered during some checkpoint data gathering action. Finally, line 212 represents the actual performance of the organization as reported in a final impact report, and which constitutes the actual performance of the organization through the final data gathered. Thus as can be seen in this example, the participant's expectations of the organization were lower than the actual performance of the organization. Because of the better than expected performance of the organization as determined in a checkpoint data gathering step, this would be an example of when participant's might choose to adjust the targeted ROI to a somewhat higher percentage because perhaps initial expectations were too low, and checkpoint data gathering indicated that actual performance was better than expected.

FIG. 5 illustrates another graphical diagram 220 which provides data regarding sales cycle times measured in days. In this example, a pre-course estimate 222 would be provided by the participant's through a survey. Then, a post-course projection 224 would also be solicited from the participants. Line 226 represents the sales cycle time at some point during checkpoint data gathering, and the actual sales cycle time is shown as the final data 228. In this example, the pre-course expectations closely matched the actual sales cycle time, while both the post-course and checkpoint predictions were not as accurate as the pre-course estimate. Sales cycle time would be but one example of a measure which could be used for measuring the efficiency/performance of a sales organization wherein minimizing the sales cycle time increases possible sales because more sales can take place if a sales cycle time is minimized.

FIG. 6 illustrates a graphical diagram of an organizational monetary benefits. In this example, a graph is plotted for isolation factor benefits, i.e., how much revenue is generated by the participant's indicating that such revenue was solely due to the training event. Thus, this graph 230 provides yet another example of how the method of this invention can be put into visual terms for a clear understanding of the process. As with FIG. 4, the months 232 represent the time period of the ROI study, and the benefits are illustrated in terms of monetary benefits 234. In this example, there are three lines which are plotted, namely, a post-course estimate line 236, a checkpoint line 238, and a final impact line 240. The final impact line 240 represents the actual isolation factor benefit which the participants attribute to the training after final data gathering has occurred. In this example, it can be seen that as the ROI study progresses, the participants attribute increased credit to the training for being responsible for certain revenue generated during the time period of the study.

For each of the graphs shown in FIGS. 4, 5 and 6, this information may be provided to participants, training personnel, and managers through the data processing system of the invention wherein one or more of the servers have the capability to create the data in these graphs based upon the various surveys and other information which is gathered from participants and managers throughout the ROI study.

FIG. 7 illustrates a sample user interface screen which could be displayed on either a participant's computer, or a manager's computer. This screen allows the participants and/or managers to update the isolation credit and the ROI goal in order to view how the breakeven point, benefit to cost ratio and ROI might change. This screen is shown as screen 250 wherein the existing isolation credit is shown at box 252, the existing ROI goal is shown at box 254, the user may input a new isolation credit at box 256, and a new ROI goal at box 258. These values can then be saved by clicking on the button 260. Based upon the previously gathered data (e.g., the participant's baseline data, the various costs data, and data reflective of the performance changes), inputting a new isolation credit and ROI goal allows a participant/manager to view changes in the breakeven point, the benefit to cost ratio and the actual ROI.

Now, referring to FIG. 8, a sample graph can be produced by one of the servers communicating with the participants' computers and/or the managers' computers. FIG. 8 illustrates a graph showing when a breakeven point is achieved. The breakeven point is defined as when the cost of the training and the cost of the ROI study are covered by the change in performance (i.e., revenue produced). In the example of FIG. 8, the cost estimate for the time period of the study is fairly constant, i.e., just below the two million dollar point. This cost estimate line is shown as line 272. The graph 270 also includes three additional lines which include various projections of performance (i.e., revenue production), as well as an additional line showing the actual final revenue produced over the time period of the study. The initial projection is shown as line 274. This initial revenue projection corresponds to the projection provided by participants immediately after the training event. This line intersects the cost estimate line between the three and six month time period, thus, the breakeven point occurs at the intersection. The second projection line is shown as checkpoint projection 276. As shown for line 276, it intersects the cost estimate line at approximately the three month period after course completion. Finally, there is the actual revenue produced, shown as line 278. Lines 276 and 278 extend together until the three month checkpoint where the lines separate, as shown. Thus, after final data collection, it can be seen that the actual breakeven point for the study was approximately at the three month period. Referring back to FIG. 7, of course, the final revenue line 278 of FIG. 8 cannot be provided until the study period ends; however, the post-course projection line would be altered based upon how the isolation credit and ROI goal were modified. Thus, participants and managers can continually update the isolation credit and ROI goal to determine when the breakeven point might occur. As checkpoint data gathering occurs, approaching the final data gathering, because better information is available, any changes to the isolation credit and ROI goal will more closely match the final revenue line 278.

Now referring to FIG. 9, the data entered in FIG. 7 as to the isolation credit and the ROI goal can also result in a display of the information in FIG. 9 on the participant/manager computers. As shown in FIG. 9, a simple benefit to cost ratio can be calculated, as well as a six month ROI. For the cost ratio, this is shown at line 280, while the six month ROI is shown at line 282. The six month benefit to cost ratio as well as the six month ROI can be calculated based upon information available just after the training event or course, during checkpoint data gathering, or can be calculated, of course, upon final data gathering. For post-course information, this is shown at column 284, checkpoint information shown at column 286, and final data resulting in a final ROI shown at column 288. In the specific example of FIG. 9, it can be seen that the post-course prediction for the benefit to cost ratio was only 0.13, (13%), while the checkpoint column and the final ROI column illustrate a greatly increased benefit to cost ratio. For the six month ROI, it is shown for post-course projection 284, there is actually a negative projection, that is, that there will actually be a negative return based upon the perceived value of the training at that point in time. However, it is then seen at columns 286 and 288 during later data gathering that the six month ROI actually results in a more positive return, to include an actual final ROI of 57.49%. As discussed above, factors which affect the ROI include costs of the training, costs of conducting the ROI study, updating the isolation credit, and evaluating the actual change of performance on the job which is a function of revenue produced by the organization and revenue produced by the participants of the training.

The invention herein has been described with respect to a preferred embodiment herein; however, it shall be understood that various modifications can be made within the spirit and scope of the invention.

What is claimed is:

1. A method of maximizing the value of a performance enhancing program measured as a return on investment, said method comprising the steps of:
collect data reflective of projected costs incurred by conducting the performance enhancing program and by participating in a study of the value of the program measured as the return on investment, and collect data reflective of projected performance change to be achieved after the program;
store the data in a first computer means;
estimate an isolation factor reflective of the perceived value of the program, as a function of its impact on performance by the participants of the program;
estimate a desired return on the investment;
determine required revenue to cover the costs of the program and to achieve the desired return on investment;
further collect the data which includes participant baseline data, and store the data in the first computer means;
conduct the program;
update the isolation factor;
update the data reflective of costs and the data reflective of performance change and store the updated data in the first computer means;
refine the desired return on investment based upon changes in required revenue to cover costs of the program and to achieve the desired return on investment;
generate a baseline report using the computer means, the baseline report including information on the isolation factor, the target return on investment, and the required revenue;
conduct checkpoint data gathering to update data reflective of the costs and the performance change, and to update the isolation factor, the data gathered during checkpoint data gathering being stored in the first computer means, said checkpoint data gathering occurring at specified times after the program;
estimate an actual return on investment and compare to the desired return on investment;
conduct final data gathering and a final update of the isolation factor, and store the final data in the computer means;
calculate the actual return on investment; and
generate an impact report by the computer means including a summary of the data gathered and the performance of the participants study, and the value of the program measured as the calculated return on investment.

2. A method, as claimed in claim 1, further including the steps of:
estimating intangible benefits and updating the intangible benefits at least once before and after the program has been conducted, said intangible benefits being incorporated within said baseline report and said impact report, said intangible benefits being those benefits which are not definable in terms of revenue.

3. A method, as claimed in claim 1, further including the steps of:
providing the first computer means for participant data entry, and providing a remote server for storing and manipulating the participant data, and to generate the baseline and impact reports.

4. A method, as claimed in claim 1, further including the steps of:
providing at least one second computer means for manager data entry reflective of modifications to participant data entry; and
collecting data from the managers and storing the data in the second computer means, the second computer means communicating with the first computer means wherein the data collected from the managers updates data collected from participants.

5. A method, as claimed in claim 1, further comprising the step of:
updating the desired return on investment at least twice after the program and prior to calculating the actual return on investment.

6. A method, as claimed in claim 1, further comprising the step of:
generating an action report after said third estimating step.

7. A system for executing a method of maximizing the value of a performance enhancing program measured as a return on investment, said system comprising:
at least one computer means for data entry, storage and data manipulation;
at least one server communicating with the at least one computer means for receiving the data, storing the data, and further manipulating the data based upon software in the server manipulated by user executable commands, the server being capable of producing reports including graphical outputs, wherein;
data is collected reflective of costs incurred by conducting the program and by participating in a study of the value of the program and data is collected reflective of performance change to be achieved, the value of the program being measured as the return on investment, the data is stored in the computer means, an isolation factor is estimated reflective of the perceived value of the program as a function of its impact on performance by the participants of the program, a desired return on the investment is estimated, required revenue is determined to cover the costs of the program and to achieve the desired return on investment, further data is collected which includes participant baseline data, and the further data is stored in the computer means, the desired return on investment is refined based upon changes in required revenue, a baseline report is generated by the computer means, the baseline report including information on the isolation factor and the target return on investment and the required revenue, checkpoint data gathering is conducted to update data reflective of the costs and performance change and the isolation factor, said updated data being stored in the computer means, said checkpoint data gathering occurring at specified times after the program, final data gathering is conducted and the isolation factor is finalized, the final data is stored in the computer means, the actual return on investment is determined, and an impact report is generated by the at least one server including a discussion of the value of the program measured as the calculated return on investment.
